(19) United States
(12) Patent Application Publication
(10) Pub. No.: US 2007/0220037 A1
(43) Pub. Date: Sep. 20, 2007

(54) Expansion phrase database for abbreviated terms

(75) Inventors: Abhinai Srivastava, Redmond, WA (US); Lee Wang, Kirkland, WA (US); Ying Li, Bellevue, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: Microsoft Corporation, Redmond, WA (US)

(21) Appl. No.: 11/378,280

(22) Filed: Mar. 20, 2006

(51) Int. Cl. G06F 7/00

(52) U.S. Cl. 707/102

(57) ABSTRACT

A system and method are disclosed for creating a database of expansion phrases for abbreviated terms. The database can be created by submitting a plurality of abbreviated terms and receiving a corresponding results set. The possible expansion phrases can be extracted from the results set, and expansion phrases are selected from the possible expansion phrases using filter rules. The selected expansion phrases may be ranked in a particular order, associated with the abbreviated term, and stored in a database.

### CROSS-REFERENCE TO RELATED APPLICATION

Not applicable.

### STATEMENT REGARDING FEDERALLY SPONSORED RESEARCH OR DEVELOPMENT

Not applicable.

### BACKGROUND

In the field of online advertising, determining which web pages to place advertisements can be an important decision. It can be desirable to place advertisements on a web page that a specific target market frequently visits, or on a web page that is related to the marketed product. It can also be desirable to place advertisements on a search results page corresponding to particular search query. Conventionally, advertisers can bid on search queries submitted by users of a search engine in order display their advertisements on the corresponding search results page.

An advertiser may want to associate as many search terms and variations of those search terms as possible to their advertisements. Such search terms may include abbreviated terms that may refer to one or more expanded phrases. When bidding on particular abbreviated terms, an advertiser may desire to invest in only on those abbreviated terms that will lead to search results that are related to the advertised product or service. Conventionally, advertisers have to manually select which abbreviated terms correspond to search results of their related product or service. Accordingly, it may be desirable to provide a more precise way in which advertisers can determine if certain abbreviated terms produce desired search results.

### SUMMARY

A system and method are disclosed for creating a database of expansion phrases for abbreviated terms. In an embodiment, an abbreviated term is submitted and results sets corresponding to the abbreviated term submitted are received. The results set can comprise at least one search result. One or more possible expansion phrases can be generated from the result set. At least one expansion phrase can be selected from the possible expansion phrases based on filter rules. The selected expansion phrases may be ranked according to a ranking algorithm and associated with the corresponding abbreviated term.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an embodiment of a system for implementing the invention.

FIG. 2 illustrates an embodiment of a block diagram of a context-based similarity system.

FIG. 3 illustrates an another embodiment of a block diagram of a context-based similarity system.

FIG. 4 illustrates an embodiment of a block diagram of a context-based similarity system utilized with an advertising component.

FIG. 5 illustrates an embodiment of an overview example of a key phrase extraction process.

FIG. 6 illustrates an embodiment of an overview example of a Similarity Graph generation process.

FIG. 7 illustrates an embodiment of a method for creating the expansion phrase database.

FIG. 8 illustrates an embodiment of a search results set.

### DETAILED DESCRIPTION

The invention introduces a system and method for creating a database of expansion phrases for abbreviated terms. Such a database can be helpful for determining the most common expansions of abbreviated terms. In an embodiment, the method can submit an abbreviated term and receive a corresponding results set. One or more possible expansion phrases can be generated from the results set, and expansion phrases can be selected from possible expansion phrases using one or more filter rules. The selected expansion phrases can be ranked, associated with the abbreviated term, and stored in a database.

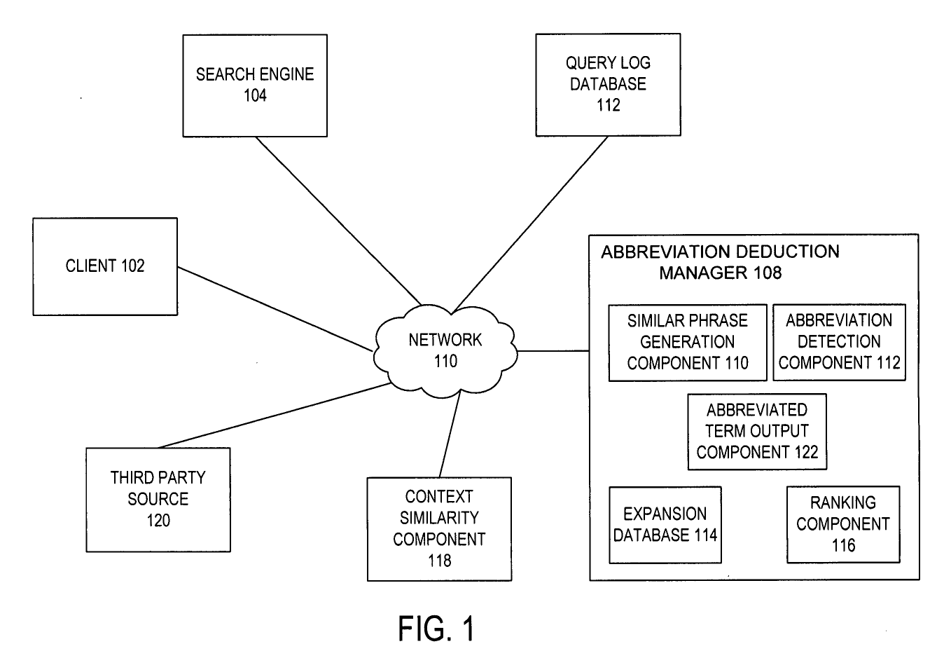

FIG. 1 illustrates an embodiment of a system for implementing the invention. Client 102 may be or include a desktop or laptop computer, a network-enabled cellular telephone (with or without media capturing/playback capabilities), wireless email client, or other client, machine or device to perform various tasks including Web browsing, search, electronic mail (email) and other tasks, applications and functions. Client 102 may additionally be any portable media device such as digital still camera devices, digital video cameras (with or without still image capture functionality), media players such as personal music players and personal video players, and any other portable media device. Client 102 can be used by an user to transmit or receive any type of information.

Search engine 104, query log database 106, abbreviation deduction manager 108, context-based similarity system 118, and third party source 120 can be a server including a workstation running the Microsoft Windows®, MacOS™, Unix, Linux, Xenix, IBM AIX™, Hewlett-Packard UX™, Novell Netware™, Sun Microsystems Solaris™, OS/2™, BeOS™, Mach, Apache, OpenStep™ or other operating system or platform. As shown in FIG. 1, devices 104, 106, 108, 118, and 120 are separate devices, however, in other embodiments, one or more devices can be integrated into one or more other devices. In another embodiment, client 102 may also be a server.

Client 102 can include a communication interface. The communication interface may be an interface that can allow the client to be directly connected to any other client, server, or device or allows the client 102 to be connected to a client, server, or device over network 122. Network 122 can include, for example, a local area network (LAN), a wide area network (WAN), or the Internet. In an embodiment, the client 102 can be connected to another client, device, or server via a wireless interface.

Query log database 106 can store search queries submitted by users of search engine 104 or another search engine. In an embodiment, the context-based similarity system 118 can be used to discover key phrases and/or measure their similarity by utilizing the usage context information from search engine query logs. The similarity levels between two key phrases can then be used to narrow down the search space of several tasks in online keyword auctions, like finding the keyword/abbreviation pairs, finding frequent misspellings of a given keyword, finding key phrases with similar intention, and/or finding keywords which are semantically related and the like.

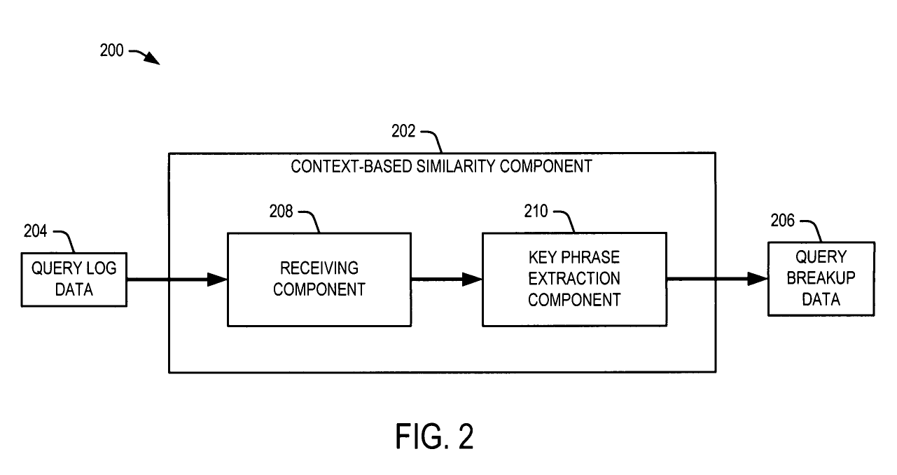

FIG. 2 illustrates an embodiment of a block diagram of a context-based similarity system 200. In an embodiment, the context-based similarity system 200 is comprised of a context-based similarity component 202 that receives query log data 204 and provides query breakup data 206. In an embodiment, the context-based similarity component 202 is comprised of a receiving component 208 and a key phrase extraction component 210. In an embodiment, the receiving component 208 obtains query log data 204 over network 122 from a data source such as, for example, query database 106. The receiving component 208 can also provide pre-filtering of the raw data from the query log data 204 if required by the key phrase extraction component 210. For example, the receiving component 208 can re-format data and/or filter data based on a particular time period, a particular network source, a particular location, and/or a particular amount of users and the like. The receiving component 208 can also be co-located with a data source. In an embodiment, the key phrase extraction component 210 receives the query log data 204 from the receiving component 208 and extracts key phrases. In other embodiments, the key phrase extraction component 210 can directly receive the query log data 204 for processing. The extracted key phrases can then be utilized to provide the query breakup data 206. The query breakup data 206 is typically a data file that is employed to determine similarity graphs for the extracted key phrases.

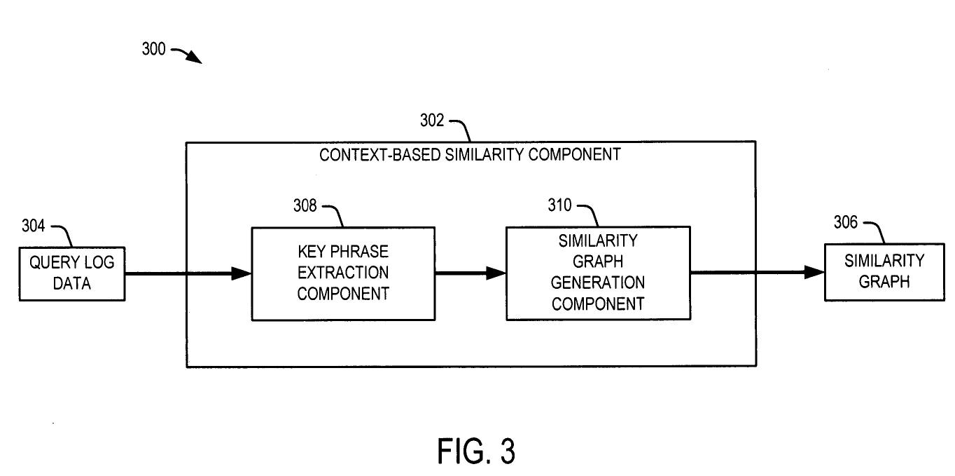

FIG. 3 illustrates another embodiment of a block diagram of a context-based similarity system 300. In an embodiment, the context-based similarity system 300 is comprised of a context-based similarity component 302 that receives query log data 304 and provides similarity graph 306. In an embodiment, the context-based similarity component 302 is comprised of a key phrase extraction component 308 and a similarity graph generation component 310. In an embodiment, the key phrase extraction component 308 obtains query log data 304 from a query log database. The key phrase extraction component 308 extracts key phrases from the query log data 304. The extracted key phrases may then be utilized to provide query breakup data to the Similarity Graph generation component 310. The Similarity Graph generation component 310 can process the query breakup data to generate the Similarity Graph 306.

In an embodiment, the context-based similarity system provides a mechanism for determining similarity between key phrases using usage context information (e.g., information apart from a focus term of a search) in search query logs. Thus, key phrases can be found which have a similar intention and/or are related conceptually by looking at the similarity of key phrase patterns around them. Moreover, algorithms can be applied for limiting the search space to only those key phrases which are similar to the given key phrase. This can make the algorithms computationally tractable and may also provide a higher accuracy for the final results.

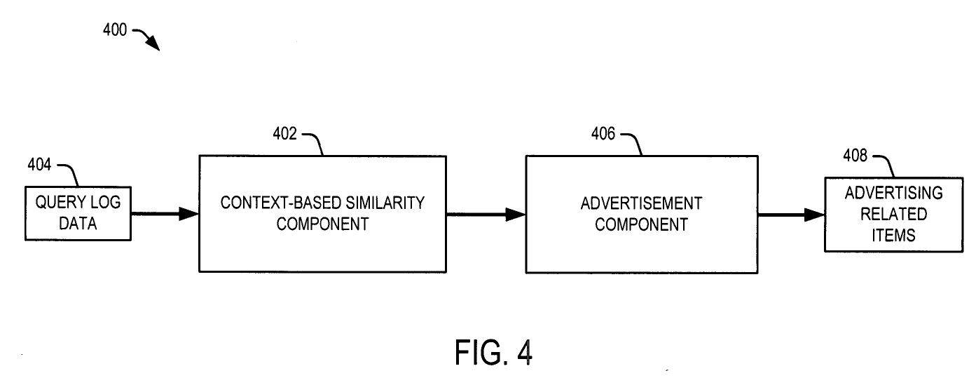

FIG. 4 illustrates an embodiment of a block diagram of a context-based similarity system 400 utilized with an advertising component 406. The context-based similarity system 400 is comprised of a context-based similarity component 402 that receives query log data 404 and interacts with advertisement component 406 which provides advertising related items 408 for advertisers. In this instance, the context-based similarity component 402 generates a Similarity Graph from the query log data 404 and provides this to the advertisement component 406. This allows the advertisement component 406 to generate advertising related items 408. The advertising related items 408 can include, for example, frequent misspellings of a given keyword, keyword/acronym pairs, key phrases with similar intention, and/or keywords which are semantically related and the like. This substantially increases the performance of the advertisement component 406 and facilitates in automatically generating terms for advertisers, eliminating the need to manually track related advertising search terms.

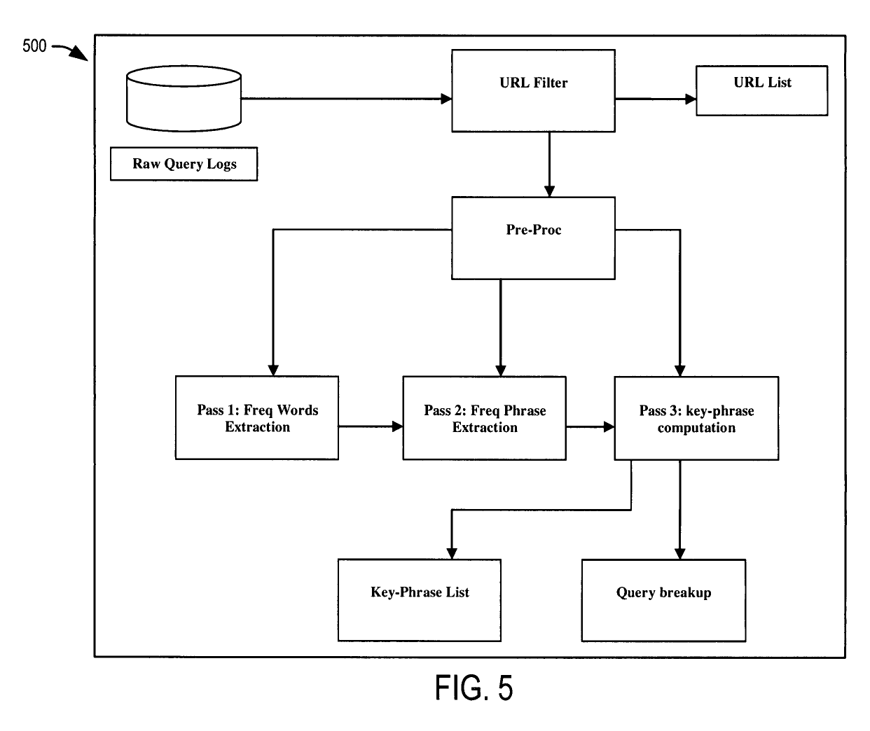

FIG. 5 illustrates an embodiment of an overview example of a key phrase extraction process 500. The key phrase extraction process 500 is generally comprised of the following passes on search query logs:

Noise Filtering: This pass includes, but is not limited to, the following: First, the query logs are passed through a URL filter which filters out queries that may happen to be URLs. This step is important for noise reduction because some of search engine logs are URLs. In an embodiment, non-alphanumeric characters, except punctuation marks, are omitted from the queries. In an embodiment, queries containing valid patterns of punctuation marks such as “.” “,” “?” and quotes and the like are broken down into multiple parts at the boundary of punctuation.

Low-frequency word filtering: In this pass, frequencies of individual words that occur in the entire query logs are determined. At the end of this pass, words which have a frequency lower than a pre-set threshold limit are discarded. This pass eliminates the generation of phrases containing infrequent words in the next step. Typically, if a word is infrequent then a phrase which contains this word is likely infrequent as well.

Key-phrase candidate generation: In this pass, possible phrases up-to a pre-set length of N words for each query are generated, where N is an integer from one to infinity. Typically, a phrase which contains an infrequent word, a stop-word at the beginning, a stop-word at the end, and/or a phrase that appears in a pre-compiled list of non-standalone key phrases are not generated. At the end of the pass, frequencies of phrases are counted and infrequent phrases are discarded. The remaining list of frequent phrases is called a “key phrase candidate list.”

Key-phrase determination: For each query, the best break is estimated by a scoring function which assigns a score of a break as sum of (n−1)×frequency+1 of each constituent key phrase. Here, n is a number of words in the given key phrase and can be an integer from one to infinity. Once the best break is determined, a real count of each constituent key phrase of the best query break is incremented by 1. This pass outputs a query breakup in a file for later use to generate a Co-occurrence Graph.

One can make an additional pass through the list of key phrases generated in the above step and discard the key phrases with a real frequency below a certain threshold when the count of obtained key phrases exceeds the maximum that is needed.

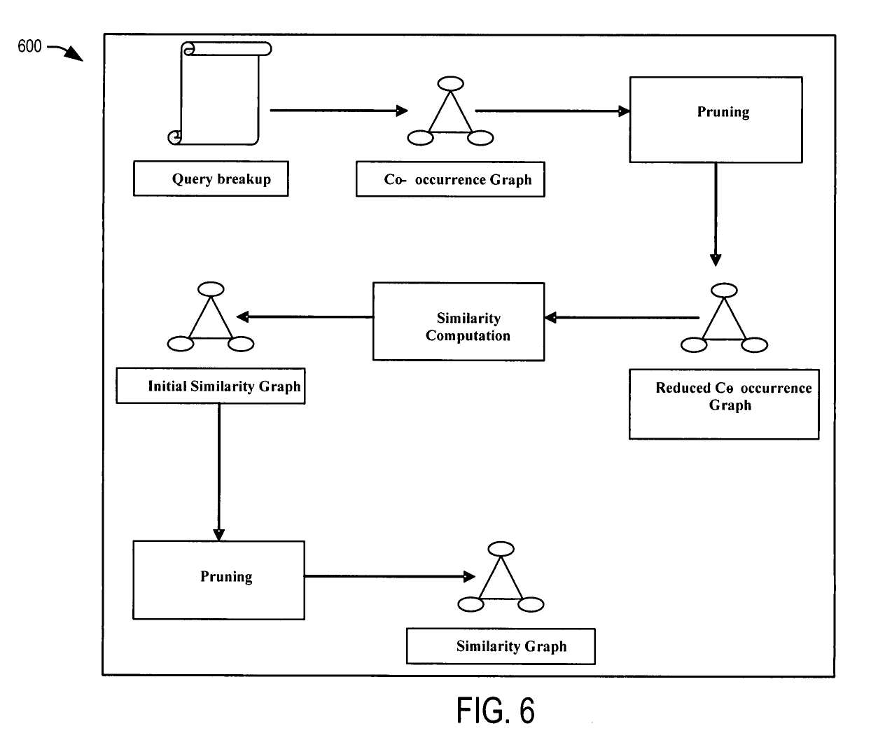

FIG. 6 illustrates an embodiment of an overview example of a Similarity Graph generation process 600. The Similarity Graph generation process 600 is typically comprised of the following:

Co-occurrence Graph generation: Using the query breakup file generated in a key phrase extraction process, a key phrase Co-occurrence Graph is generated. A Co-occurrence Graph is a graph with key phrases as nodes and edge weights representing the number of times two key phrases are part of the same query. For example, if a breakup of a query had three key phrases, namely, a, b, and c then the weights of the following edges are incremented by 1: {a,b}, {a,c} and {b,c}.

Co-occurrence Graph pruning: Once the Co-occurrence Graph has been generated, noise is removed by pruning edges with a weight less than a certain threshold. Next, nodes which have less than a certain threshold number of edges are pruned. Edges associated with these nodes are also removed. Further, the top K edges for each node are determined, where K is an integer from one to infinity. Edges, except those falling into the top K of at least 1 node, are then removed from the graph.

Similarity Graph creation: A new graph called the Similarity Graph is then created. The set of nodes of this graph is the key phrases which remain as nodes in the Co-occurrence Graph after Co-occurrence Graph pruning.

Similarity Graph edge computation: For each pair {n₁, n₂} of nodes in the Similarity Graph, an edge {n₁, n₂} is created if and only if the similarity value S(n₁,n₂) for the two nodes in the Co-occurrence Graph is greater than a threshold T. The weight of the edge {n₁,n₂} is S(n₁,n₂). The similarity value S(n₁,n₂) is defined as the cosine distance between the vectors {e₁n₁, e₂n₁ . . . } and {e₁n₂, e₂n₂ . . . }, where e₁n₁, e₂n₁ . . . are the edges connecting node n₁ in the Co-occurrence Graph and e₁n₂, e₂n₂ . . . are the edges connecting node n₂ in the Co-occurrence Graph. Cosine distance between two vectors V₁ and V₂ is computed as follows: (V₁·V₂)/|V₁|X|V₂|. A total of ˜nC₂ distance computations are required at this stage.

Similarity Graph edge pruning: The top E edges by edge weight for each node in the Similarity Graph are then determined, where E is an integer from one to infinity. The edges, except those falling in the top E edges of at least one node, are removed. Typically, the value of E is approximately 100.

Output: Output the generated Similarity Graph generated above.

The Similarity Graph can be stored in a hash table data structure for very quick lookups of key phrases that have a similar usage context as the given key phrase. The keys of such a hash table are the key phrases and the values are a list of key phrases which are neighbors of the hash key in the Similarity Graph. The main parameter to control the size of this graph is the minimum threshold value for frequent key phrases in the key phrase extraction process. The size of the Similarity Graph is roughly directly proportional to the coverage of key phrases. Hence, this parameter can be adjusted to suit a given application and/or circumstances.

Referring back to FIG. 1, in an embodiment, abbreviation deduction manager 108 can be utilized to create a database of expansion phrases for corresponding abbreviated terms. Abbreviated terms can include abbreviations and acronyms. In an embodiment, abbreviation deduction manager can include a similar phase generation component 110, an abbreviation detection component 112, an expansion database 114, a ranking component 116, and a abbreviated term output component 122.

The abbreviated term output component 122 can be, for example, a program that is configured to output a plurality of different abbreviated terms. In an embodiment, the plurality of different abbreviated terms are outputted into either a search engine or a similarity graph. In an embodiment, similar phase generation component 110 can be used to receive an output from a search engine or a similarity graph, wherein the output is a results set including at least one result. If the results set is received from the search engine, the results set can be a search results set including at least one search result corresponding to a query. In an embodiment, the query can be an abbreviated term received from the abbreviated term output component 122. If the results set is received from a similarity graph, the results set can be a nodes set including at least one node corresponding to a query. In an embodiment, the query can be an abbreviated term received from the abbreviated term output component.

Once the output is received, the similar phrase generation component can be configured to generate all possible expansion phrases from the output. In an embodiment, the expansion phrases are generated based on the query that was submitted to generate the output. The abbreviation detection component 112 can be configured to select expansion phrases from the possible expansion phrases based on filter rules. In an embodiment, a selected expansion phrase can be an expansion phrase that is most relevant to the query. The level of relevancy can be determined utilizing a relevancy determination algorithm employed by the by the abbreviation detection component. The ranking component 116 can be configured to rank the selected expansion phrases according to a ranking algorithm employed by the ranking component. The expansion phrase database 114 can associate and store the ranked expansion phrases with the corresponding query. In another embodiment, the expansion phrase database 114 can include expansion phrases and corresponding abbreviated terms received from one or more third party sources 120.

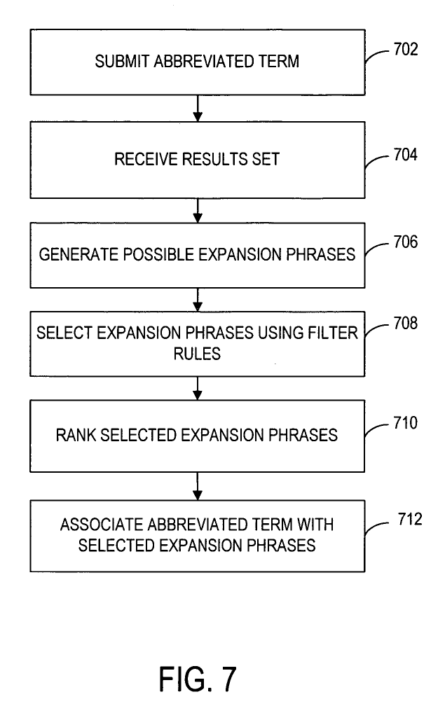

FIG. 7 illustrates an embodiment of a method for creating the expansion phrase database. At operation 702 an abbreviated term is submitted. In an embodiment, the abbreviated term is submitted from an abbreviated term output component to either a search engine or a similarity graph. At operation 704 a results set including at least one result corresponding to the abbreviated term is received. If the results set is received from the search engine, the results set can be a search results set including at least one search result corresponding to the abbreviated term. If the results set is received from a similarity graph, the results set can be a nodes set including at least one node corresponding to the abbreviated term.

At operation 706, possible expansion phrases are generated from the results of the results set. In an embodiment in which the results set is received from a similarity graph, the possible expansion phrases are generated by extracting the most relevant M nodes that are related to the abbreviated term, where M is an integer from one to infinity. The level of relevancy of the nodes to the abbreviated term can be determined by an employed algorithm.

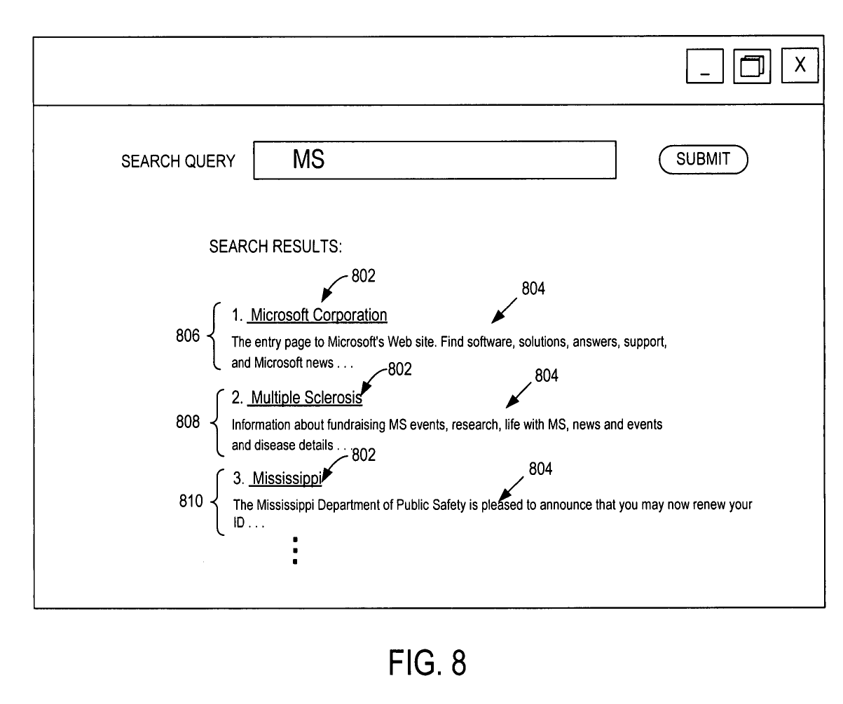

In an embodiment in which the results set is received from a search engine, the possible expansion phrases are generated by selecting the first P search results and generating possible expansion phrases from the selected search results up to length X, where P and X are integers from one to infinity and X is the number of terms in the expansion phrase. The expansion phrases can be generated from the titles of the search results, the snippets of the search results, or both the titles and snippets of the search results. The snippets of the search results can be the text that is accompanied with the title of the search result. For example, referring to FIG. 8, 802 represents the titles of the different search results and 804 represents the snippets. If P=3 then the first three search results including Microsoft Corporation, Multiple Sclerosis, and Mississippi would be selected. If X=3 then possible expansion phrases up to three terms would be generated from each selected search result. For example, looking at the Microsoft Corporation search result, possible expansion phrases from the title and snippet could be: (1) “Microsoft,” (2) “Microsoft Corporation,” (3) “Microsoft Corporation The,” (4) “entry page Microsoft's,” (5) “Web Site,” (6) “solutions,” (7) “Microsoft news,” etc.

At operation 708, expansion phrases from the possible expansion phrases are selected based on filter rules. In an embodiment, a selected expansion phrase can be a possible expansion phrase that is closely related to the abbreviated term. An algorithm utilizing any number of filter rules can be employed by the invention to determine how closely related the possible expansion phrase is to the abbreviated term. For example, one filter rule could be that the of the letters in the abbreviated term stands for a corresponding first letter of a word in the selected expansion phrase. For example, referring to FIG. 8, the abbreviated term is “MS.” Using the example filter rule, “M” would have to be the first letter of the first word in the selected expansion phrase and “S” would have to be the first letter of the second word in the phrase. From the second search result 808 “Multiple Sclerosis” would be a selected expansion phrase, and from the third search result 810 “Mississippi Safety” would be a selected expansion phrase.

Another example of a filter rule could be that the first letter in the abbreviated term is the first letter of the first word in the selected expansion phrase and the other letters of the abbreviated term can be found anywhere else in the selected expansion phrase. For example, referring to FIG. 8, as long as “M” was the first letter in the first word of a possible expansion phrase, the possible expansion phrase would be selected if “S” is found anywhere else in the possible expansion phrase. For example, “Microsoft” would be a selected expansion phrase from the first search 806 result as well as “Microsoft news.” From the second search result 808, “Multiple Sclerosis” and “Multiple events” would also be selected expansion phrases. Once the selected expansion phrases are identified, the possible expansions that were not identified can be discarded.

At operation 710, the selected expansion phrases are ranked. In an embodiment, the selected expansion phrases are ranked in order of the frequency the selected expansion phrases are found within query log database 106 (FIG. 1). For example, if a first selected expansion phrase has a higher usage rate over a second selected expansion phrase determined by the query log database, then the first selected expansion phrase can be ranked higher than the second. In an embodiment in which the results are received from a search engine, the selected expansion phrases can be ranked in order that the selected expansion phrases are found within the search results set. For example, referring to FIG. 8, selected expansion phrases derived from the first result 806 can be ranked higher than selected expansion phrases derived from the second 808 and third 810 search results, and selected expansion phrases derived from the second search results can be ranked higher than selected expansion phrased derived from the third search result. At operation 712, the ranked selected expansion phrases can be associated with the corresponding abbreviated term and stored in expansion phrase database 114 (FIG. 1).

While particular embodiments of the invention have been illustrated and described in detail herein, it should be understood that various changes and modifications might be made to the invention without departing from the scope and intent of the invention. The embodiments described herein are intended in all respects to be illustrative rather than restrictive. Alternate embodiments will become apparent to those skilled in the art to which the present invention pertains without departing from its scope.

From the foregoing it will be seen that this invention is one well adapted to attain all the ends and objects set forth above, together with other advantages, which are obvious and inherent to the system and method. It will be understood that certain features and sub-combinations are of utility and may be employed without reference to other features and sub-combinations. This is contemplated and within the scope of the appended claims.

We claim:

1. A method for creating a database of expansion phrases for abbreviated terms, comprising:
receiving a results set corresponding to an abbreviated term, the results set comprising at least one result;
generating one or more expansion phrases from the results set;
selecting at least one of the generated expansion phrases based on one or more filter rules;
associating the abbreviated term with the at least one selected expansion phrase.

2. The method according to claim 1, further comprising ranking the at least one selected expansion phrase.

3. The method according to claim 2, further comprising ranking the at least one selected expansion phrase according to the frequency that the at least one selected expansion phrase is found within a query log.

4. The method according to claim 1, wherein the results set is received from a similarity graph.

5. The method according to claim 2, wherein the results set is received from a search engine.

6. The method according to claim 5, further comprising ranking the at least one selected expansion phrase according to the order the at least one selected expansion phrase is found within the results set from the search engine.

7. The method according to claim 5, wherein the one or more expansion phrases are generated from at least one of a title of the result and a snippet of the result.

8. The method according to claim 1, wherein identifying the at least one selected expansion phrase comprises comparing the at least one abbreviated term to the one or more expansion phrases.

9. A system for creating a database of expansion phrases for abbreviated terms, comprising:
a phrase generation component for receiving a results set corresponding to an abbreviated term and generating one or more expansion phrases from the results set, the results set including at least one result;
an abbreviation detection component for selecting at least one of the generated expansion phrases based on one or more filter rules;
a ranking component for ranking the at least one selected expansion phrase; and
a database for associating the abbreviated term with the at least one selected expansion phrase.

10. The system according to claim 9, wherein the one or more expansion phrases are generated from at least one of a title of the result and a snippet of the result.

11. The system according to claim 9, wherein the ranking component ranks the at least one selected expansion phrase according to the frequency that the at least one selected expansion phrase is found within a query log.

12. The system according to claim 9, wherein the results set is received from a search engine.

13. The system according to claim 12, wherein the ranking component ranks the at least one selected expansion phrase according to the order the at least one selected expansion phrase is found within the results set from the search engine

14. The system according to claim 9, wherein the abbreviation detection component identifies the at least one selected expansion phrase by comparing the at least one abbreviated term to the one or more expansion phrases.

15. The system according to claim 14, wherein the abbreviation detection component compares the at least one abbreviated term by identifying letters within the one or more expansion phrases that are found in the at least one abbreviated term.

16. One or more computer-readable media having computer-usable instructions stored thereon for performing a method for creating a database of expansion phrases for abbreviated terms, the method comprising:
receiving a results set corresponding to an abbreviated term, the results set comprising at least one result;
generating one or more expansion phrases from the results set;
selecting at least one of the generated expansion phrases based on one or more filter rules;
associating the abbreviated term with the at least one selected expansion phrase.

17. The computer readable media according to claim 16, further comprising ranking the at least one selected expansion phrase.

18. The computer readable media according to claim 17, wherein the results set is received from a search engine.

19. The computer readable media according to claim 18, further comprising ranking the at least one selected expansion phrase according to the order the at least one selected expansion phrase is found within the results set from the search engine.

20. The computer readable media according to claim 18, wherein the one or more expansion phrases are generated from at least one of a title of the result and a snippet of the result.
